(19) United States
(12) Patent Application Publication
(10) Pub. No.: US 2004/0264360 A1
(43) Pub. Date: Dec. 30, 2004

(54) Information storage medium

(75) Inventors: Kyung-geun Lee, Seongnam-si (KR); Tatsuhiro Otsuka, Suwon-si (KR); Wook-yeon Hwang, Yangpyeong-gun (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/845,513

(22) Filed: May 14, 2004

(30) Foreign Application Priority Data
May 20, 2003 (KR) 2003-31908

(51) Int. Cl. G11B 7/24; G11B 5/55

(52) U.S. Cl. 369/275.4; 369/275.2

(57) ABSTRACT

An information storage medium includes BCA marks, having unique information, formed near the outer edge of the information storage medium. The BCA marks may be formed at the outermost edge of the information storage medium. This new layout enables miniaturization of the information storage medium so that the information storage medium is applicable to portable information recording and reproduction apparatuses.

### CROSS-REFERENCE TO RELATED APPLICATIONS

This application claims priority from Korean Patent Application No. 2003-31908, filed on May 20, 2003, in the Korean Intellectual Property Office, the disclosure of which is incorporated herein by reference in its entirety.

### BACKGROUND OF THE INVENTION

1. Field of the Invention

The present invention relates to an information storage medium, and more particularly, to an information storage medium having a new layout based on a variation in the location of burst cutting area (BCA) marks including unique information.

2. Description of the Related Art

Referring to FIG. 1, BCA marks 10 according to an information storage medium such as a conventional optical disk 12 appear as radial bars near the center of the optical disk 12.

The BCA marks 10 include unique information about the optical disk 12 such as serial numbers and a manufacturing date. A section of the optical disk 12 in which the BCA marks 10 are formed is referred to as a “BCA field” or a “BCA”. The BCA marks 10 are generally formed on a track-free mirror area so that information readout can commence immediately after a pickup beam is focused on the surface of the optical disk 12. Generally, the radial length of the BCA marks 10 is about 1 mm. However, in DVD-R/RW or CD-R/RW in which a power calibration area (PCA) and a program memory area (PMA) are present between a BCA and a lead-in area, the radial length of the BCA marks 10 is about 0.8 mm.

Referring to FIG. 2, the optical disk 12 includes, in sequence from an inner edge to an outer edge, a clamping area, a BCA, a lead-in area, a data area, and a lead-out area. That is, the BCA is generally located between the clamping area and the lead-in area.

Generally, the BCA marks 10 have a width of 10 to 15 μm and a radial length of 1 mm, and thus, can be easily visualized. For example, the amount of data recorded on the optical disk 12 with a radius of 21.5 mm is equal to about 4,000 to 5,000 channel bits in a single rotation. When the circumference (2π×21.5) of the optical disk 12 is divided by the number of the channel bits, each channel bit occupies 25 to 30 μm. The BCA marks 10 can be formed with a width of about 12 μm using a modern BCA descriptor.

Recently, however, a miniature optical disk used in digital cameras, camcorders, cellular phones, MP3, and the like has been formed with a diameter smaller than a 120 mm diameter of a currently used optical disk, for example, a 50 mm diameter. In such a miniature optical disk, when BCA marks having a radial length of at least 1 mm are formed between radii of 6 and 7 mm as shown in FIG. 1, each channel bit in a BCA of 7 mm in radius occupies about 9 to 9.5 μm, which is larger than the width of BCA marks that can be formed by a current BCA descriptor. Therefore, a new layout format suitable for a miniature optical disk is required.

### SUMMARY OF THE INVENTION

The present invention provides an information storage medium having a new layout format in which BCA marks can be formed even when the information storage medium is miniaturized.

According to an aspect of the present invention, there is provided an information storage medium including BCA marks having unique information, and the BCA marks are formed near the outer edge of the information storage medium.

In an aspect of the present invention, the BCA marks are formed at the outermost edge of the information storage medium.

In an aspect of the present invention, the BCA marks are marked in a radial direction on the surface of the information storage medium.

In an aspect of the present invention, the BCA marks are circularly or rectangularly arranged on the surface of the information storage medium.

In an aspect of the present invention, the BCA marks are formed by burning up predetermined portions of a reflective film of the information storage medium with a laser beam or by forming crystalline or amorphous marks using a phase-change material.

In an aspect of the present invention, the information storage medium includes, in sequence from an outer edge to an inner edge, a BCA with the BCA marks, a lead-in area, a data area, and a lead-out area.

In an aspect of the present invention, the BCA marks are formed on a land or a groove.

In an aspect of the present invention, the information storage medium are a single layer type, a multi-layer type, a one side type, or a two side type, and the BCA marks are formed in at least one layer or side of the information storage medium.

In an aspect of the present invention, the unique information includes serial numbers and manufacturing date about the information storage medium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic plan view of a conventional optical disk with an array of BCA marks;

FIG. 2 is a schematic layout of the optical disk of FIG. 1;

FIG. 3 is a schematic plan view of an information storage medium according to an embodiment of the present invention;

FIG. 4 is a schematic sectional view of the information storage medium shown in FIG. 3;

FIG. 5 is a schematic layout of the information storage medium of FIG. 3; and

FIGS. 6A-6D are schematic timing charts that illustrate recorded data bits, recording signals, reproduction signals, and reproduced data bits, respectively, in the information storage medium shown in FIG. 3.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

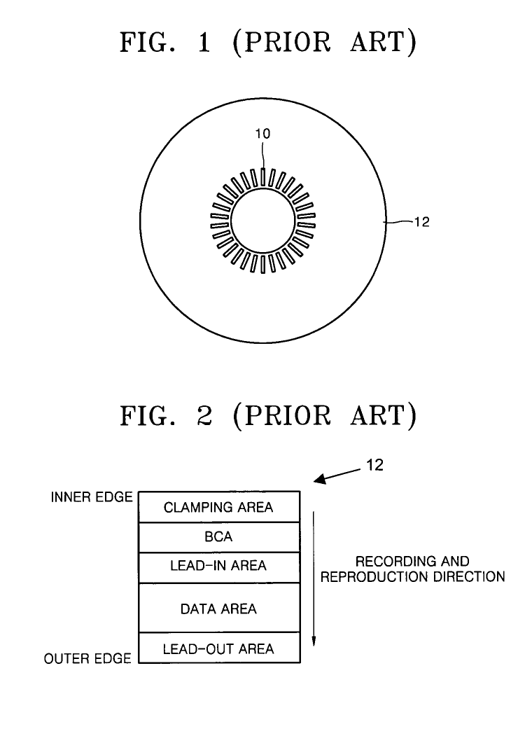

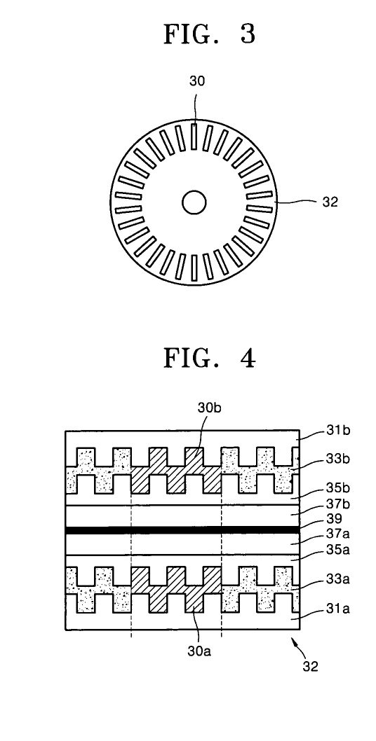

Referring to FIG. 3, an information storage medium 32 according to an embodiment of the present invention is a miniature information storage medium 32 with a diameter smaller than a conventional information storage medium such as the optical disk 12 of FIG. 1. Burst cutting area (BCA) marks 30 are formed at the outermost edge of the information storage medium 32. The BCA marks 30 may be formed by burning up predetermined portions of a reflective film of the information storage medium 32 with an optical source such as a laser or by forming crystalline or amorphous marks using a phase-change material. The BCA marks 30 are circularly or rectangularly arranged on the surface of the information storage medium 32. The BCA marks 30 may be formed on a land or a groove on the surface of the information storage medium 32. For example, when a miniature information storage medium has a diameter of 50 mm and a track pitch of 0.32 μm, the length of the BCA marks can be reduced to at least 0.133 μm.

Referring to FIG. 4, the information storage medium 32 has a symmetric structure about an adhesive layer 39. That is, a first recording film 33a and a second recording film 33b are respectively formed on a first substrate 31a and a second substrate 31b. A first reflective film 35a and a first protective film 37a are sequentially formed on the first recording film 33a. A second reflective film 35b and a second protective film 37b are sequentially formed on the second recording film 33b.

In an embodiment of the present invention shown in FIG. 4, when the information storage medium 32 is made from a phase change material, the BCA marks 30 of FIG. 3 may be formed based on a phase-change principle so that an optical signal can be detected by the difference of reflectivity between a crystalline state and an amorphous state. The BCA marks 30 may be represented as first and second crystalline marks 30a and 30b in the first and second recording films 33a and 33b of FIG. 4, respectively. The first and second crystalline marks 30a and 30b have a reflectivity of 20% or more, which is higher than that of amorphous marks (not shown). Detection of the difference of reflectivity enables reproduction of BCA codes recorded on the BCA marks 30.

The first and second crystalline, bar code type BCA marks 30a and 30b in the recording films of FIG. 4 are arranged in a concentric radial distribution between a clamping area and a lead-in area (or a PCA in DVD-R/RW or CD-R/RW). BCA codes are recorded on the crystalline marks 30a created by transformation of predetermined portions of an amorphous recording film, for example the first recording film 33a, to crystalline portions after deposition of a BCA, regardless of whether the information storage medium 32 is a single layer type, a multi-layer type, a one side type, or a both side type. According to a phase-change BCA mark recording method of the present invention, the formation of the BCA marks 30 can be carried out simultaneously with initialization of the information storage medium 32 using a conventional initialization apparatus. Therefore, a separate apparatus and additional initialization time are not required. It will be understood by those of ordinary skill in the art that BCA codes can be recorded on other type marks instead of bar code type marks.

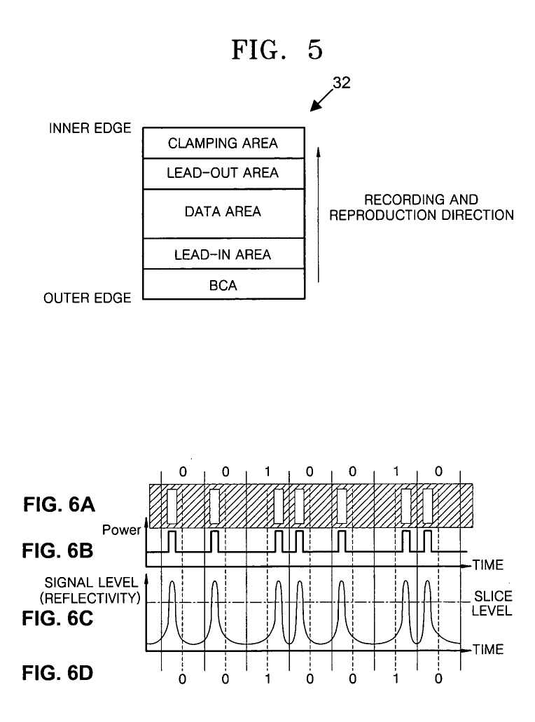

The information storage medium 32 has the BCA marks 30 near its outer edge, and thus, can be formed as a miniature information storage medium. A new layout format as shown in FIG. 5 is suitable for such a miniature information storage medium.

Referring to FIG. 5, the information storage medium 32 includes, in sequence from an outer edge to an inner edge, a BCA, a lead-in area, a data area, a lead-out area, and a clamping area. The clamping area may have various areas according to the type of the information storage medium 32. This layout format, and more specifically, the array from the inner edge to the outer edge of the information storage medium 32 of FIG. 5, is opposite to that of the optical disk 12 of FIG. 2.

The layout format of the information storage medium 32 is based on the principle that when information recording and/or reproduction is carried out in the information storage medium 32, the recording and/or reproduction of unique information about the information storage medium 32 on the BCA marks 30 precedes sequential information recording and/or reproduction in the lead-in area, the data area, and the lead-out area. This order of recording and/or reproduction is consistent with that of a conventional information storage medium, and thus maintains compatibility with a conventional recording and/or reproduction apparatus.

FIGS. 6A-6D are schematic timing charts that illustrate the relation between recorded data bits, recording signals, reproduction signals, and reproduced data bits, respectively, in an information storage medium 32 according to an embodiment of the present invention.

As shown in FIG. 6A, “0” indicates a case where a bar code type mark is formed at an early stage and “1” indicates a case where a bar code type mark is formed at a later stage. FIG. 6B shows the power of a laser beam necessary for formation of the bar code type marks shown in FIG. 6A. FIG. 6C shows synchronized signals by filtration with a high frequency pass filter. As illustrated, the reflectivity of bar code type marks is higher than that of surrounding areas. As shown in FIG. 6D, the reproduced data is “0010010”, which is the same as the recorded BCA code data shown in FIG. 6A.

An information storage medium according to an embodiment of the present invention has a layout format in which a BCA, a lead-in area, a data area, and a lead-out area are sequentially formed from an outer edge to an inner edge. Such a layout format enables easy realization of a miniature information storage medium.

As is apparent from the above descriptions, since an information storage medium of the present invention can be easily miniaturized, it is easily applicable to a portable information storage medium driving apparatus.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An information storage medium, comprising:
burst cutting area (BCA) marks formed near an outer edge of the information storage medium, the BCA marks comprising unique information.

2. The information storage medium of claim 1, wherein the BCA marks are formed at the outer edge of the information storage medium.

3. The information storage medium of claim 1, wherein the BCA marks are marked in a radial direction on a surface of the information storage medium.

4. The information storage medium of claim 1, wherein the BCA marks are circularly or rectangularly arranged on a surface of the information storage medium.

5. The information storage medium of claim 1, wherein the BCA marks are formed by burning up predetermined portions of a reflective film of the information storage medium with a laser beam or by forming crystalline or amorphous marks using a phase-change material.

6. The information storage medium of claim 1, which comprises, in sequence from an outer edge to an inner edge, a BCA with the BCA marks, a lead-in area, a data area, and a lead-out area.

7. The information storage medium of claim 1, wherein the BCA marks are formed on a land or a groove.

8. The information storage medium of claim 1, wherein the information storage medium comprises a single layer type, a multi-layer type, a one side type, or a two side type, and;
the BCA marks are formed in at least one layer or side of the information storage medium.

9. The information storage medium of claim 1, wherein the unique information comprises serial numbers and a manufacturing date about the information storage medium.

10. A method of arranging areas on an information storage medium, comprising:
forming burst cutting area (BCA) marks near an outer edge of the information storage medium.

11. The method of claim 10, wherein the forming of the BCA marks comprises selectively changing the phase of a phase-change material on a surface of the information storage medium.

12. The method of claim 10, wherein the forming of the BCA marks comprises selectively removing with a light source portions of a reflective film on a surface of the information storage medium.

13. The method of claim 10, further comprising:
forming a lead-in area, a data area, and a lead-out area sequentially on a surface of the information storage medium from the BCA marks near the outer edge to an inner edge of the information storage medium.

14. The method of claim 13, wherein the forming of the BCA marks are formed at the outer edge of the information storage medium.

15. The method of claim 13, further comprising:
forming a clamping area near the inner edge of the information storage medium.

16. The method of claim 13, wherein the information storage medium is a miniature information storage medium.

17. The method of claim 13, the forming of the BCA marks comprises encoding unique information.

18. The method of claim 17, further comprising:
initializing the information storage medium in a recording and/or reproduction apparatus simultaneously with the forming of the BCA marks.

19. The method of claim 18, wherein recording and/or reproducing of the unique information precedes recording and/or reproducing of the lead-in area, the data area, and the lead-out area.

20. A miniature information storage medium for use with a recording and/or reproduction apparatus, comprising:
a burst cutting area (BCA), a lead-in area, a data area, and a lead-out area sequentially formed from an outer edge of the miniature information storage medium to an inner edge of the miniature information storage medium.

21. The miniature information storage medium of claim 20, wherein an order of the BCA, the lead-in area, the data area, and the lead-out area is opposite that of a conventional information storage medium.
